(19) United States
(12) Patent Application Publication
(10) Pub. No.: US 2026/0074894 A1
(43) Pub. Date: Mar. 12, 2026

(54) DETERMINING SHARED SECRETS USING A BLOCKCHAIN

(71) Applicant: nChain Licensing AG, Zug (CH)

(72) Inventors: Daniel JOSEPH, London (GB); Craig Steven WRIGHT, London (GB)

(21) Appl. No.: 19/105,278

(22) PCT Filed: Aug. 16, 2023
(86) PCT No.: PCT/EP2023/072543

§ 371 Date: Feb. 20, 2025

(30) Foreign Application Priority Data
Sep. 8, 2022 (GB) 2213095.9

(51) Int. Cl. H04L 9/08; H04L 9/00; H04L 9/30

(52) U.S. Cl. CPC H04L 9/0841; H04L 9/3066; H04L 9/50

(57) ABSTRACT

A method for enabling a second party to determine a shared cryptographic key, comprising: generating a puzzle blockchain transaction comprising one or more outputs, each output comprising a puzzle locking script, wherein each puzzle locking script comprises a target public key and is configured to, when executed together with a unlocking script comprising a candidate value, convert the candidate value into a candidate public key and require the candidate public key to match the target public key; and sending the puzzle blockchain transaction to one or more nodes of a blockchain network and/or the second party, wherein the first party is configured to generate the shared cryptographic key based on the first private key, the second public key, and each target public key, and wherein the second party is configured to generate the shared cryptographic key based on the second private key, the first public key, and each candidate value.

### CROSS REFERENCE TO RELATED APPLICATIONS

This application is the U.S. National Stage of International Application No. PCT/EP2023/072543 filed on Aug. 16, 2023, which claims the benefit of United Kingdom Patent Application No. 2213095.9, filed on Sep. 8, 2022, the contents of which are all incorporated herein by reference in their entireties.

### TECHNICAL FIELD

The present disclosure relates to methods of determining a shared secret (i.e. a shared cryptographic key) using blockchain transactions, where the shared secret can be determined by two parties

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below.

Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

The Diffie-Hellman (DH) key exchange is a method for two parties (each possessing a public-private key pair) with no required previous knowledge of each other, to securely exchange a cryptographic key over a public channel. After the exchange, both parties can then utilise said key as a symmetric key for future communications between each other. In the DH exchange, both parties (e.g. Alice and Bob) first exchange their respective public keys, then each party (e.g. Alice) performs a function on the other's (Bob's) public key with the party's (Alice's) private key. The outcome of this function is the shared symmetric cryptographic key S_{AB} that either party can generate with only knowledge of the other's public key.

There are scenarios where it would be desirable for one of two parties to only be able to calculate a shared key once certain conditions have been met. For example, the party may be required to perform one or more actions before they are able to calculate the shared key.

According to one aspect disclosed herein, there is provided a computer-implemented method for enabling a second party to determine a shared cryptographic key, wherein a first party has a first private key and corresponding first public key, and the second party has a second private key and corresponding second public key, and wherein the method is performed by the first party and comprises: generating a puzzle blockchain transaction, wherein the puzzle blockchain transaction comprises one or more respective outputs, each respective output comprising a respective puzzle locking script, wherein each respective puzzle locking script comprises a respective target public key and is configured to, when executed together with a respective unlocking script comprising a respective candidate value, convert the respective candidate value into a respective candidate public key and require the respective candidate public key to match the respective target public key; and sending the puzzle blockchain transaction to one or more blockchain nodes of a blockchain network and/or the second party, wherein the first party is configured to generate the shared cryptographic key based on the first private key, the second public key, and each respective target public key, and wherein the second party is configured to generate the shared cryptographic key based on the second private key, the first public key, and each respective candidate value.

According to another aspect disclosed herein, there is provided a computer-implemented method of determining a shared cryptographic key, wherein a first party has a first private key and corresponding first public key, and the second party has a second private key and corresponding second public key, wherein a blockchain comprises a puzzle blockchain transaction, wherein the puzzle blockchain transaction comprises one or more respective outputs, each respective output comprising a respective puzzle locking script, wherein each respective puzzle locking script comprises a respective target public key and is configured to, when executed together with a respective unlocking script comprising a respective candidate value, convert the respective candidate value into a respective candidate public key and require the respective candidate public key to match the respective target public key, and wherein the method is performed by the second party and comprises: obtaining one or more respective reveal blockchain transactions, wherein each respective reveal blockchain transaction comprises one or more respective inputs, each respective input referencing a respective one of the one or more respective outputs of the puzzle blockchain transaction and comprising a respective unlocking script, each respective unlocking script comprising a respective candidate value; and generating the shared cryptographic key based on the second private key, the first public key, and each respective candidate value key, wherein the first party is configured to generate the shared cryptographic key based on the first private key, the second public key, and each respective target public key.

According to another aspect disclosed herein, there is provided a computer-implemented method for enabling a second party to determine a shared cryptographic key, wherein a first party has a first private key and corresponding first public key, and the second party has a second private key and corresponding second public key, wherein a blockchain comprises a puzzle blockchain transaction, wherein the puzzle blockchain transaction comprises one or more respective outputs, each respective output comprising a respective puzzle locking script, wherein each respective puzzle locking script comprises a respective target public key and is configured to, when executed together with a respective unlocking script comprising a respective candidate value, convert the respective candidate value into a respective candidate public key and require the respective candidate public key to match the respective target public key, and wherein the method is performed by a third party and comprises: generating one or more respective candidate values; generating one or more respective reveal blockchain transactions, wherein each respective reveal blockchain transaction comprises one or more respective inputs, each respective input referencing a respective one of the one or more respective outputs of the puzzle blockchain transaction and comprising a respective unlocking script, each respective unlocking script comprising a respective candidate value; and sending the one or more respective reveal blockchain transactions to one or more blockchain nodes of a blockchain network, the first party, and/or the second party.

Embodiments of the present disclosure enable a first party (e.g. Alice) to prevent a second party (e.g. Bob) from being able to calculate a shared key until a series of candidate values (i.e. private keys) are revealed on the blockchain. The private keys are known in advance to Alice, and so Alice can choose to calculate the shared key and use the shared key in advance of Bob being able to calculate the same key, e.g. to encrypt a message. The private keys required by Bob in order to generate the shared key are revealed in one or more reveal transactions, from which they can be extracted by Bob. In some examples, each of the revealed private keys is linked to a condition, such that the private key necessary to unlock the corresponding puzzle locking script is only generated, or becomes available, when the condition is met.

Knowledge of the revealed private keys is not enough to calculate the shared key. Similarly, knowledge of the corresponding public keys, which are included in the puzzle transaction, is not enough to calculate the shared key. Instead, only Alice and Bob can calculate the shared key as only they have access to their own, secret private keys.

Put another way, the present disclosure provides a technique where the private key necessary for a party (e.g. Bob) in the exchange is not known to the individual (Bob) until certain conditions are met that satisfy the other party (Alice). The enforcement of these conditions takes place via the blockchain through the use of the blockchain's scripting functionality. After the conditions are met, Bob is then able to utilise the information found on the immutable chain to generate the public-private key pair that Alice utilises in the DH exchange. This is accomplished without the private keys of Alice or Bob being compromised, nor the existing security of the DH exchange.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain, and

FIG. 3 schematically illustrates an example system for generating a shared cryptographic key.

### DETAILED DESCRIPTION OF EMBODIMENTS

### 1. Example System Overview

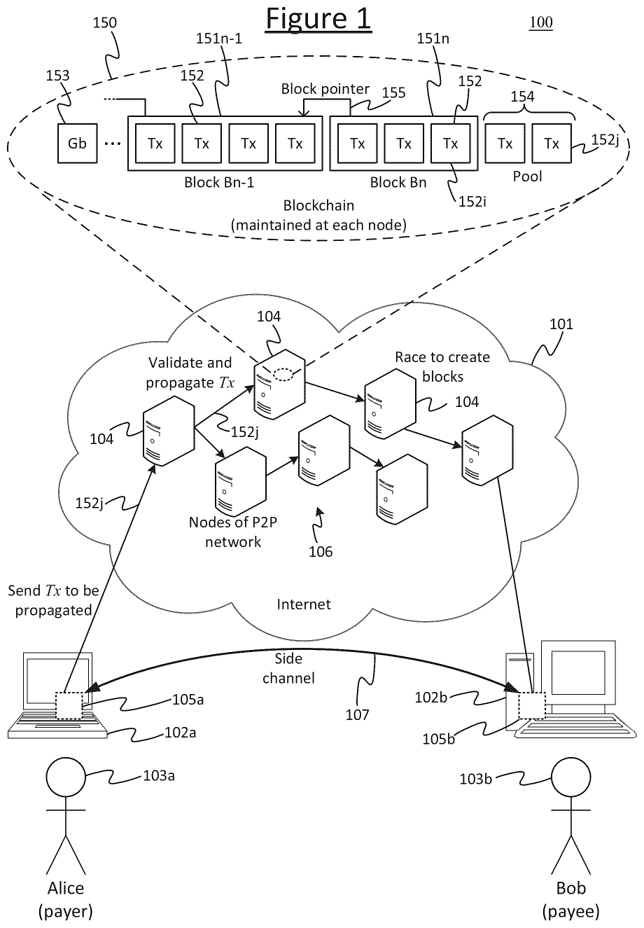

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106.

The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility).

The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly.

In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

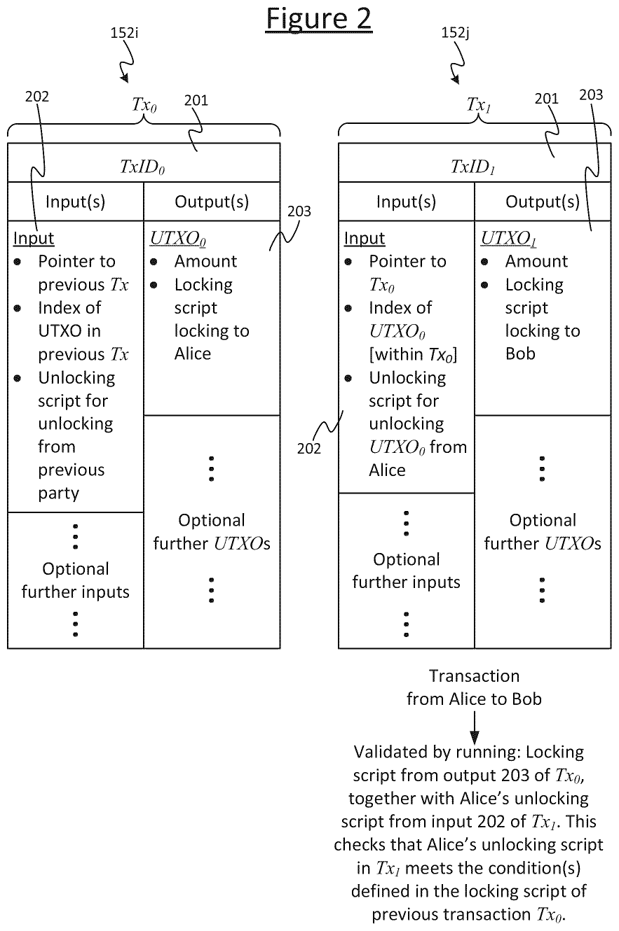

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$< Sig {P}_{A} > < {P}_{A} > \vert \vert [ Checksig {P}_{A} ]$$

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Cryptographic Techniques

### 4.1 Elliptic Curves

An elliptic curve (EC) is the set of points described by the equation

$${y}^{2} ≡ {x}^{3} + ax + b ( mod p )$$

where 4a³+27b²≢0 (mod p) and p is prime. The parameters for the elliptic curve utilised in Bitcoin and its variations is the secp256k1 standard.

For EC cryptography, given a private key v, the corresponding public key is

$$Q = vG$$

where G is a base point on the Elliptic Curve.

### 4.2 Diffie-Hellman

The Diffie-Hellman exchange is described here with respect to elliptic curves.

Two parties (Alice 103a and Bob 10b) wish to establish a shared secret between themselves and to be able to establish this shared secret while communicating through a public channel. To do so, they perform the following.
1. Each party creates their public-private key pair using secp256k1. Bob (v_{B}, P_{B}), Alice (v_{A}, P_{A}) where P_{B}=v_{B}G and P_{A}=v_{A}G.
2. Each party shares their public key with the other. Bob gives Alice the key P_{B}, Alice gives Bob the key P_{A}. This can be done over a public channel.
3. Each party multiplies the other's public key by their (original party's) private key. Bob calculates v_{B}P_{A}. Alice calculates v_{A}P_{B}.
4. Both parties are now in possession of the shared key that can be used for symmetric encryption.

$${S}_{AB} = {V}_{B} {P}_{A} = {V}_{A} {P}_{B} = {v}_{B} {v}_{A} G = {v}_{A} {v}_{B} G$$

Neither party needs to know the other's private key and a third party is unable to determine S_{AB} as they would not have knowledge of either private key, v_{A} or v_{B}.

### 4.3 Elliptic Curve Homomorphism

The public-private key relationship of EC encryption is homomorphic. This is for addition for a base point G:

$$mG + nG = ( m + n ) G$$

where m is the private key for public key P_{M}=m_{G}, n is the private key for public key Pₙ=nG, and G is a base point on the Elliptic Curve.

### 4.4 Elliptic Curve Opcode

PCT/IB2018/052407 shows the Bitcoin protocol is able to carry out EC finite field arithmetic. This includes the multiplication of a scalar by a point on the EC. That is, the calculation vG, where G is the base point, can be calculated in Script.

An example function (e.g. opcode, or pseudo-opcode) that performs elliptic curve multiplication is referred to here as OP_ECPMULT. OP_ECPMULT takes an encoded elliptic curve point and a number and performs elliptic curve multiplication by scalar. It outputs the result as an encoded elliptic curve point. Note that OP_ECPMULT is merely a label for a function that performs these actions, and any other equivalent function with a different label may be used instead.

### 5. Determining Shared Keys

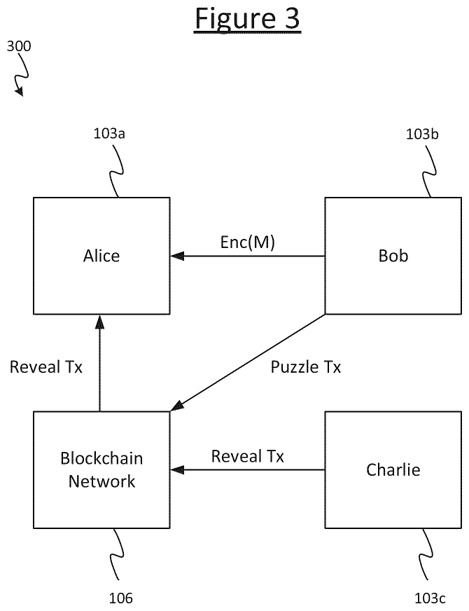

Embodiments of the present disclosure relate to determining a shared key between two parties. The shared key may be used as, or to device, a symmetric encryption key. FIG. 3 illustrates an example system 300 for determining a shared key. In this example, the system 300 includes a first party (e.g. Alice 103a), a second party (e.g. Bob 103b), a third party (e.g. Charlie 103c) and one or more blockchain nodes 104 of a blockchain network 106. In some examples, the third party is the same as the first or second party. Whilst only one third party is shown, the system 300 may comprise multiple respective third parties, each configured to perform equivalent actions. Note that whilst the first and second parties are rereferred to as Alice 103a and Bob 103b respectively, this is merely for convenience and in general the first and second party need only be able to perform the actions described below as being performed by Alice 103a and Bob 103b respectively. Moreover, in general each of the first and second party may each perform any action described above, with reference to FIGS. 1 and 2, as being performed by Alice 103a and/or Bob 103b. Alice 103a and Bob 103b each have their own public-private key pair. These may be referred to as their main, or primary, key pairs.

Alice 103a would like to enable Bob 103b to calculate a shared secret at some time in the future, e.g. after (or only if) one or more conditions have been met. Each condition may be linked with (e.g. mapped to) a respective private key. These private keys (e.g. 256 bit integers) may be referred to as secondary private keys. These private keys will, at some point, be revealed on the blockchain 150.

Alice 103a creates a puzzle transaction (a specific example of a puzzle transaction is shown below in Table 1). The puzzle transaction includes one or more outputs. Each output includes a locking script, which will be referred to as a “puzzle locking script”. Note that the puzzle transaction may contain additional outputs that do not include these locking scripts. Each puzzle locking script contains a respective public key corresponding to one of the secondary private keys. These public keys may therefore be referred to as “secondary public keys”. They are also referred to herein as “target public keys”. Each puzzle locking script is configured to require an unlocking script that is executed together with the puzzle locking script to contain a candidate value matching one of the secondary private keys. To implement this requirement, the puzzle locking script converts the candidate value (provided as an input from the unlocking script of spending transaction) into a public key (a “candidate public key”) and requires the candidate public key to match the target public key included in the puzzle locking script.

Conversion of the candidate value into a candidate public key may involve performing elliptic curve multiplication of the candidate value with an elliptic curve generator point (e.g. the base point). The puzzle locking script may include a dedicated function (e.g. an opcode, such as OP_ECPMULT) for performing said multiplication.

Determining whether the candidate public key matches the target public key may involve comparing the candidate public key with the target public key. The puzzle locking script may include a dedication function (e.g. an opcode, such as OP_EQUALVERIFY) for this purpose.

In some examples, the puzzle locking script requires a portion of script that forces the unlocking script, which is executed together with the puzzle locking script, to require a signature corresponding with a particular public key. Here, a signature corresponds to a public key if it was generated using a private key corresponding to the public key. This allows Alice 103a to dictate who can unlock each of the puzzle locking scripts. One, some or all of the puzzle locking scripts may require a signature generated by the same entity, e.g. the same third party, such as Charlie 103c. Alternatively, one, some or all of the puzzle locking scripts may require a signature generated by a different entity. In some examples, Alice 103a is required to generate at least one of the signatures. In some examples, Bob 103b is required to generate one of the signatures. Generating a signature may be taken to mean that the entity who generated the signature also provided the candidate value (i.e. secondary private key) that is included in the same unlocking script as the signature.

In some examples, the puzzle locking script requires multiple signatures in order to be unlocked. This may be enforced using a multi-signature locking (sub-) script. A multi-signature locking script comprises multiple public keys, and requires an unlocking script that attempts to unlock the multi-signature locking script to comprise signatures matching (some or all) of the provided public keys. In some examples, at least one of the public keys is Alice's (e.g. her main public key), such that Alice 103a must provide a corresponding signature in order to unlock the puzzle locking script. Aa specific example of a puzzle transaction requiring multiple signatures is shown below in Table 3.

Alice 103a submits the puzzle transaction to the blockchain network 106. Additionally or alternatively, Alice 103a may send the puzzle transaction to Bob 103b and/or Charlie 103a, either of whom may send the puzzle transaction to the blockchain network 106.

Alice 103a may generate the shared key in advance of, or after, sending the puzzle transaction to the blockchain network 106 and/or other parties. Alice 103a is able to generate the shared key using her main private key, Bob's main public key, and each of the secondary public keys (i.e. the target public keys). The shared key may be generated by summing each of the public keys (Bob's main public key and the secondary public keys) and multiplying the result with Alice's main private key. Note that all arithmetic here is elliptic curve arithmetic.

Alice 103a may use the shared key to encrypt a message. The encrypted message may be sent to Bob 103b, e.g. before submitting the puzzle transaction to the blockchain network 106.

Turning now to the revelation of the secondary private keys that enable Bob 103b to calculate the shared key. Once the puzzle transaction is published on the blockchain 150, one or more reveal transactions may be submitted to the blockchain 150 that together reveal the required secondary private keys. In some examples, a single reveal transaction is generated that includes each of the secondary private keys. In other examples, multiple reveal transactions may be generated, where each reveal transaction includes at least one of the secondary private keys.

The reveal transaction(s) may be generated by Charlie 103c. In some examples, Charlie 103c generates each reveal transaction. In other examples, Charlie 103c generates one or more of the reveal transactions and a different third party, or parties, generate(s) one or more of the reveal transactions. In some examples, a single reveal transaction is generated but is contributed to by multiple parties, e.g. multiple third parties, Alice 103a, and/or Bob 103b.

In the case where a single reveal transaction is generated, Charlie 103c generates (or at least obtains) at least one of the secondary private keys, and includes the secondary private key in an input of the reveal transaction that references one of the outputs of the puzzle transaction, i.e. in an unlocking script of that input. The reveal transaction has respective inputs referencing respective outputs of the puzzle transaction, each including a respective unlocking script that includes a respective secondary private key. Charlie 103c may obtain each candidate value himself. Alternatively, one or more candidate values may be obtained from a different party, e.g. Alice 103a or Bob 103b. The reveal transaction is sent to the blockchain network 106, either directly by Charlie 103c or via a different party, e.g. Alice 103a or Bob 103b. The case where multiple reveal transactions are generated is similar. The difference is that each reveal transaction only includes some, but not all of the secondary private keys.

In some examples, each unlocking script is required to include a signature corresponding to a particular public key. For example, Charlie 103c may generate a signature using a private key corresponding to one of his public keys that is included in a puzzle locking script of the puzzle transaction. In examples where Alice 103a and/or Bob 103b provide a secondary private key, they may also generate a signature for inclusion in the respective unlocking script that includes the respective secondary private key. In some examples, Alice 103a may only sign the reveal transaction if it includes a lock time.

The secondary private keys may be generated (or obtained) in any suitable way. For instance, Alice 103a may provide Charlie 103c with the secondary private key(s). As another example, each secondary private key may be mapped to a respective value (e.g. a real-world event), such that by knowing (or determining) the value, the corresponding secondary private key may be obtained.

Submitting the reveal transaction(s) to the blockchain enables Bob 103b to determine the shared key. That is, Bob 103b is able to obtain the secondary private keys which becomes public once the reveal transaction(s) are recorded on the blockchain 150. Bob 103b may obtain the reveal transaction(s), from which the secondary private keys may be extracted, or he may obtain just the secondary private keys. Bob 103b may receive the transactions from one or more blockchain nodes 104, or from Alice 103a, or from Charlie 103c.

Having obtained the secondary private keys, Bob 103b generates the shared key using his main private key, Alice's main public key, and each of the secondary private keys (i.e. the values that were included in the unlocking script(s) of the reveal transaction(s)). The shared key may be generated by summing each of the private keys (Bob's main private key and the secondary private keys) and multiplying the result with Alice's main public key.

Bob 103b may perform one or more actions using the shared key. For example, Alice 103a may send a message to Bob 103b which has been encrypted using the shared key. Bob 103b may used the shared key to decrypt the encrypted message. Similarly, Bob 103b may encrypt a message with the shared key and send the encrypted message to Alice 103a. Thus Alice 103a and Bob 103b may communicate securely using the shared key.

The shared key may be used for purposes other than encryption. For example, Bob 103b being able to generate the key may be used to indicate that Bob 103b (or entities controlled or associated with Bob 103b) have performed one or more actions, each action resulting in one of the secondary private keys being revealed.

### 6. Conditional DH Key Exchange

This section provides specific example implementations of the described embodiments. It will be appreciated that some of the examples are optional. Any example described in this section may be used in conjunction with the examples described in the section above.

### 6.1 Base Version

The premise of the present disclosure is for two parties (Alice 103a, Bob 103b) to securely determine a common key S_{AB}, where communication between both parties is assumed to be via a public channel. Importantly, for one party (e.g. Bob 103b), they should not be able to determine the secret S_{AB} until some conditions that were set by the other party (Alice 103a) are satisfied.

The n criteria set by Alice 103a may be arbitrary, on-chain or off-chain. For the present example it is assumed that satisfaction of the criteria makes available to the entity that satisfied the criteria one or more integer values, where each value can each serve as the private key for an EC public-private key pair.

While the conditions may be satisfied off-chain, proof of knowledge of these values is to be provided on-chain. Note that it is not necessarily Bob 103b who is asked to satisfy the criteria or provides this on-chain proof, but if the proof is provided on chain by any third party, then it is assumed that Bob 103b is able to determine the vᵢ values.

With this in mind, example steps of the protocol are as follows:
1. Each party creates their public-private key pair. Bob (v_{B}, P_{B}), Alice (v_{A}, P_{A}) where P_{B}=v_{B}G and P_{A}=v_{A}G.
2. Each parties shares their public key with the other. Bob 103b gives Alice 103a the key P_{B}, Alice 103a gives Bob 103b the key P_{A}.
3. Alice 103a creates the set of criteria {Cᵢ|i∈[1,n]} where the solution to Cᵢ is vᵢ, and vᵢ is an integer such that 1≤vᵢ≤m−1 where m is the order of the subgroup with base point G.
4. Alice 103a creates a blockchain transaction TxID_{Puzzles} (Table 1) where the locking script of one or more outputs of this transaction requires knowledge of the set of vᵢ values in order to spend the output. In the example transaction shown in Table 1 there is one vᵢ value requested for each output. The unlocking script of the transaction that successfully spends the i output of TxID_{Puzzles} needs to include the v; value that when multiplied by the EC base point G produces the public key Pᵢ=vᵢG. Alice 103a knows each vᵢ value or at least their corresponding Pᵢ values.

The verification that the correct vᵢ value is produced in the unlocking script that utilises an opcode such as OP_ECPMULT.

TABLE 1
Puzzle Transaction.
TxID_{Puzzles}

| | | | |
|---|---|---|---|
| Version | 1 | nLockTime | — |
| In-count | 1 | Out-count | n |

| Input list | | Output list | |
|---|---|---|---|
| | Unlocking | | |
| Outpoint | script | Value | Locking script |
| Alice's | <Sig_{Alice}> | x₁ sat | <basepoint G> OP_ECPMULT <P₁> |
| outpoint | | | OP_EQUALVERIFY OP_DUP OP_HASH160 |
| 0 | | | <H(P_{e, 1})> OP_EQUALVERIFY OP_CHECKSIG |
| | | x₂ sat | <basepoint G> OP_ECPMULT <P₂> |
| | | | OP_EQUALVERIFY OP_DUP OP_HASH160 |
| | | | <H(P_{e, 2})> OP_EQUALVERIFY OP_CHECKSIG |
| | | . | . |
| | | . | . |
| | | . | . |
| | | xₙ sat | <basepoint G> OP_ECPMULT <Pₙ> |
| | | | OP_EQUALVERIFY OP_DUP OP_HASH160 |
| | | | <H(P_{e, n})> OP_EQUALVERIFY OP_CHECKSIG |

5. Alice 103a informs Bob 103b of these criteria and the availability of said transaction.
6. Alice 103a informs Bob 103b that the cryptographic key S_{AB} that both parties are to share will be Alice's private key times

$${P}_{B}^{*}$$

where

$${P}_{B}^{*}$$

is equal to ‘P_{B}+the sum of the Pᵢ values’. Alice's private key v_{A} is not shared with Bob 103b.

$${S}_{AB} = {v}_{A} {P}_{B}^{*} = {v}_{A} ( {P}_{B} + {P}_{1} + {P}_{2} + … + {P}_{n} ) = {v}_{A} ( {P}_{B} + {\sum }_{i = 1}^{n} {P}_{i} )$$

Alice 103a performs this calculation.
7. For Bob 103b to determine the secret key S_{AB} he needs to calculate

$${S}_{AB} = {v}_{B}^{*} {P}_{A}$$

$$where$$

$${v}_{B}^{*} = {v}_{B} + {v}_{1} + {v}_{2} + … + {v}_{n}$$

This is as

$${v}_{B}^{*} {P}_{A} = {v}_{A} {P}_{B}^{*} = ( {v}_{B} + {v}_{1} + {v}_{2} + … + {v}_{n} ) {v}_{A} G = {v}_{A} ( {v}_{B} + {v}_{1} + {v}_{2} + … + {v}_{n} ) G$$

However, Bob 103b does not yet know the values v₁, v₂, . . . , vₙ so he is unable to determine S_{AB}. He will obtain these v; values if the Cᵢ outputs of transaction TxID_{Puzzles} are spent and thus visible on the blockchain. Each of these outputs is expected to be spent by an entity (e,i), e.g. Charlie 103c. These ‘entities’ could be unique individuals (including being Alice 103a) or one entity being able to spend multiple Cᵢ outputs.

In this example, to spend the output, the entity must provide both the v; value that produces Pᵢ=vᵢG and a signature using their personal private-public key pair (v_{e,1}, P_{e,i}). The latter requirement for the signature is to ensure that only the intended entity can spend the output. In some examples, each value vᵢ is a hash of a number.

An example of a reveal transaction (TxID_{v_reveal}) that spends one or more Cᵢ output is shown in Table 2Table 2.

TABLE 2
v_reveal transaction
TxIDᵥ_{_{—}}ᵣₑᵥₑₐₗ

| | | | |
|---|---|---|---|
| Version | 1 | nLockTime | — |
| In-count | n | Out-count | n |

| | |
|---|---|
| Input list | Output list |

| | Unlocking | | |
|---|---|---|---|
| Outpoint | script | Value | Locking script |
| TXID_{Puzzles} | [symbol] v₁ [symbol] [symbol] P_{e, 1} [symbol] | x₁ sat | P2PKH P_{e, 1} |
| outpoint 0 | [symbol] sigP_{e, 1} [symbol] | | |
| TXID_{Puzzles} | [symbol] v₂ [symbol] [symbol] P_{e, 2} [symbol] | x₂ sat | P2PKH P_{e, 2} |
| outpoint 1 | [symbol] sigP_{e, 2} [symbol] | | |
| | . | . | . |
| | . | . | . |
| | . | . | . |
| TXID_{Puzzles} | [symbol] vₙ [symbol] [symbol] P_{e, n} [symbol] | xₙ sat | P2PKH P_{e, n} |
| outpoint | [symbol] sigP_{e, n} [symbol] | | |
| n − 1 | | | |

Note the provision of the vᵢ value in the unlocking scripts. This v_reveal transaction is submitted to the blockchain.

The notation P2PKH Pᵢ is used to represent the standard P2P2KH locking script for a public key Pᵢ. i.e.:

$$P 2 PKH {P}_{i} = OP\_DUP OP\_HASH160 < H ( {P}_{i} ) > OP\_EQUALVERIFY OP\_CHECKSIG$$

8. When all Cᵢ outputs of TxID_{Puzzles} are spent, i.e., the TxID_{v_reveal} transaction is submitted to the blockchain, all the vᵢ values are available to any interested party. In this case, the interested party is Bob 103b who now calculates

$${v}_{B}^{*} = {v}_{B} + {v}_{1} + {v}_{2} + … + {v}_{n}$$

Bob 103b now calculates the shared key

$${S}_{AB} = {v}_{B}^{*} {P}_{A} = ( {v}_{B} + {v}_{1} + {v}_{2} + … + {v}_{n} ) {P}_{A}$$

The security of the exchange is maintained as neither party knows the other's private key (Bob 103b does not know v_{A} and Alice 103a does not know v_{B}) and a third party is unable to determine S_{AB} as they would not have knowledge of either private key, v_{A} or v_{B}. Note that v_{B} is necessary for the calculation of

$${v}_{B}^{*} .$$

### 6.2 Time Lock Version

In the basic version described above, Bob 103b is able to retrieve the vᵢ values necessary to produce

$${v}_{B}^{*}$$

when the transaction TxID_{v_reveal} is successfully submitted to the blockchain. Bob's determination of S_{AB} is thus dependent on when this transaction is uploaded. This gives Alice 103a the ability to impose a time-delay (albeit limited) on Bob 103b obtaining S_{AB}.

Alice 103a may include a value s for the nTimeLock parameter of the TxID_{v_reveal} transaction. nLockTime is a transaction parameter that allows a transaction to only be executable after a specified time has passed. This means that despite knowing the vᵢ values, and even creating the complete TxID_{v_reveal} transaction, the transaction itself cannot be successfully included to the blockchain until time s has passed. The nLockTime value may either be Unix time value or a block height of the blockchain

In order to implement this, the TxID_{Puzzles} transaction is changed to include an m-of-n multisig locking script (m ≥2) in each of the Cᵢ outputs, where one of the signatures must be by Bob's. The revised TxID_{Puzzles} is shown in Table 3. The multisig prevents an entity from removing the timelock from the spending transaction by requiring Alice 103a to sign the transaction.

TABLE 3
Puzzle Transaction (Multisig)
TxID_{Puzzles}

| | | | |
|---|---|---|---|
| Version | 1 | nLockTime | — |
| In-count | 1 | Out-count | n |

| Input list | | Output list | |
|---|---|---|---|
| | Unlocking | | |
| Outpoint | script | Value | Locking script |
| Alice's | <Sig_{Alice}> | x₁ sat | <basepoint G> OP_ECPMULT <P₁> |
| outpoint | | | OP_EQUALVERIFY 2 <P_{e, 1}> <P_{Alice}> 2 |
| 0 | | | CHECKMULTISIG |
| | | x₂ sat | <basepoint G> OP_ECPMULT <P₂> |
| | | | OP_EQUALVERIFY 2 <P_{e, 2}> <P_{Alice}> 2 |
| | | | CHECKMULTISIG |
| | | . | . |
| | | . | . |
| | | . | . |
| | | xₙ sat | <basepoint G> OP_ECPMULT <Pₙ> |
| | | | OP_EQUALVERIFY 2 <P_{e, n}> <P_{Alice}> 2 |
| | | | CHECKMULTISIG |

Alice's required signature for the m-of-n locking script may be based on the P_{A} being used in the secret key exchange. For improved security, Alice 103a may use another of her public keys for this signature. For simplicity, any of these other public keys of Alice 103a is referred to as the generic P_{Alice}.

The transaction TxID_{v_reveal} is also changed to accommodate the multisig revisions of the TxID_{Puzzles} transaction (See Table 4). In the construction of the TxID_{v_reveal} transaction, the nLockTime parameter is set to s by Alice 103a.

FIG. 4: v_reveal transaction (Timelock)
TxIDᵥ_{_{—}}ᵣₑᵥₑₐₗ

| | | | |
|---|---|---|---|
| Version | 1 | nLockTime | s |
| In-count | n | Out-count | n |

| | |
|---|---|
| Input list | Output list |

| | Unlocking | | |
|---|---|---|---|
| Outpoint | script | Value | Locking script |
| TXID_{Puzzles} | [symbol] v₁ [symbol] | x₁ sat | P2PKH P_{e, 1} |
| outpoint 0 | [symbol] sigP_{e, 1} [symbol] | | |
| | [symbol] sigP_{Alice} [symbol] | | |
| TXID_{Puzzles} | [symbol] v₂ [symbol] | x₂ sat | P2PKH P_{e, 2} |
| outpoint 1 | [symbol] sigP_{e, 2} [symbol] | | |
| | [symbol] sigP_{Alice} [symbol] | | |
| | . | . | . |
| | . | . | . |
| | . | . | . |
| TXID_{Puzzles} | [symbol] vₙ [symbol] | xₙ sat | P2PKH P_{e, n} |
| outpoint | [symbol] sigP_{e, n} [symbol] | | |
| n − 1 | [symbol] sigP_{Alice} [symbol] | | |

The input scripts of TxID_{v_reveal} that unlock the Cᵢ outputs of TxID_{Puzzles} now each require a signature from Alice 103a. Alice 103a provides these signatures to the corresponding entity who owns the public key P_{e,i}. Blockchain signatures (like Alice's) sign the (double hash of) messages that are extracts from the transaction being signed. While components of the extracts of the transaction are optional (based on the sighash flag used), others like the nLockTime value are always included. The implication of this is that Alice's signature enforces the nLockTime=s restriction placed by Alice 103a in transaction TxID_{v_reveal}.

Each entity may then then go about generating their signature [symbol] sigP_{e,i} [symbol] and determine the vᵢ values.

Even if all three values are available ( [symbol] vᵢ [symbol] , [symbol] SigP_{e,i} [symbol] , [symbol] SigP_{Alice} [symbol] ) for all n outputs of the TxID_{v_reveal} transaction, the transaction cannot be successfully submitted to the blockchain until at least time s has passed. After time s, the transaction can be successfully submitted. This restriction is what introduces the time delay to the revelation of the vᵢ values.

When the vᵢ values are available Bob 103b may then calculate the secret value

$${S}_{AB} = {v}_{B}^{*} {P}_{A} = ( {v}_{B} + {v}_{1} + {v}_{2} + … + {v}_{n} ) {P}_{A}$$

### 6.3 Example Use Cases

Bob 103b provides a service and the entities are IoT devices that automatically produce digital signatures when certain conditions have been met. e.g. Bob 103b is transporting goods (for Alice 103a) that have the requirement of a) being kept at a certain temperature, b) arriving at a location by a time, and c) having a quality approval on arrival. If all conditions are met (essentially a checklist) then the inputs of the v_reveal transaction(s) are signed by the IoT devices and Bob 103b can calculate the shared secret. This shared secret may be used to execute an action or to communicate with Alice 103a.

Another use case is one where verification is necessary for Bob 103b to access some media that has been encrypted by Alice 103a. e.g. age restricted TV show. Alice 103a requires that Bob 103b pass several checks including: minimum age, currently has a UK address, active tv license. She encodes these conditions in the puzzles transaction and requires that appropriate third parties certify that Bob 103b meets these criteria by signing the inputs of the v_reveal transaction. Bob 103b is then able to obtain the shared secret S_{AB} that was used as symmetric key for the encryption/decryption of the media.

### 7. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method for enabling a second party to determine a shared cryptographic key, wherein a first party has a first private key and corresponding first public key, and the second party has a second private key and corresponding second public key, and wherein the method is performed by the first party and comprises:
generating a puzzle blockchain transaction, wherein the puzzle blockchain transaction comprises one or more respective outputs, each respective output comprising a respective puzzle locking script, wherein each respective puzzle locking script comprises a respective target public key and is configured to, when executed together with a respective unlocking script comprising a respective candidate value, convert the respective candidate value into a respective candidate public key and require the respective candidate public key to match the respective target public key; and
sending the puzzle blockchain transaction to one or more blockchain nodes of a blockchain network and/or the second party,
wherein the first party is configured to generate the shared cryptographic key based on the first private key, the second public key, and each respective target public key, and wherein the second party is configured to generate the shared cryptographic key based on the second private key, the first public key, and each respective candidate value.

The respective unlocking script comprising the respective candidate value may be part of a respective reveal transaction. A reveal transaction may comprise a single one of the respective unlocking scripts or multiple (e.g. all) of the respective unlocking scripts.

Statement 2. The method of statement 1, comprising generating the shared cryptographic key.

Statement 3. The method of statement 1 or statement 2, wherein each respective puzzle locking script comprises an elliptic curve generator point and a function configured to perform elliptic curve multiplication of the respective candidate value and the elliptic curve generator point.

Statement 4. The method of any preceding statement, wherein each respective puzzle locking script is configured to require a respective signature corresponding to a respective public key.

Statement 5. The method of statement 4, wherein at least one of the respective puzzle locking scripts is configured to require the respective unlocking script to comprise a respective signature corresponding to a respective public key associated with the first party.

Statement 6. The method of statement 4 or statement 5, wherein at least one of the respective puzzle locking scripts is configured to require the respective unlocking script to comprise a respective signature corresponding to a respective public key associated with the second party.

Statement 7. The method of any preceding statement, wherein each respective puzzle locking script is configured to require the respective unlocking script to comprise multiple respective signatures, each corresponding to a respective public key, and wherein at least one respective public is associated with the first party.

Statement 8. The method of statement 5 or statement 7, wherein the respective public key associated with the first party is the first public key.

Statement 9. The method of statement 2 or any statement dependent thereon, comprising:
encrypting a message using the shared cryptographic key to generate an encrypted message; and
making the encrypted message available to the second party.

Statement 10. The method of any preceding statement, comprising:
providing one or more of the respective candidate values to at least one party for inclusion in one or more respective unlocking scripts, each respective unlocking script configured to unlock a respective puzzle locking script of the puzzle blockchain transaction.

Statement 11. The method of statement 7 or any statement dependent thereon, wherein a reveal blockchain transaction comprises one or more respective unlocking scripts configured to unlock one or more respective puzzle locking scripts of the puzzle blockchain transaction, and wherein the method comprises providing, for inclusion in the respective unlocking script, a respective signature corresponding to the respective public key associated with the first party.

Statement 12. The method of statement 11, wherein the reveal blockchain transaction comprises a time lock value, wherein the time lock value prevents the reveal blockchain transaction from being recorded on the blockchain until a time corresponding to the time lock value has passed.

Statement 13. A computer-implemented method of determining a shared cryptographic key, wherein a first party has a first private key and corresponding first public key, and the second party has a second private key and corresponding second public key, wherein a blockchain comprises a puzzle blockchain transaction, wherein the puzzle blockchain transaction comprises one or more respective outputs, each respective output comprising a respective puzzle locking script, wherein each respective puzzle locking script comprises a respective target public key and is configured to, when executed together with a respective unlocking script comprising a respective candidate value, convert the respective candidate value into a respective candidate public key and require the respective candidate public key to match the respective target public key, and wherein the method is performed by the second party and comprises:
obtaining one or more respective reveal blockchain transactions, wherein each respective reveal blockchain transaction comprises one or more respective inputs, each respective input referencing a respective one of the one or more respective outputs of the puzzle blockchain transaction and comprising a respective unlocking script, each respective unlocking script comprising a respective candidate value; and
generating the shared cryptographic key based on the second private key, the first public key, and each respective candidate value key, wherein the first party is configured to generate the shared cryptographic key based on the first private key, the second public key, and each respective target public key.

Statement 14. The method of statement 13, comprising:
generating at least one respective candidate value; and
providing the at least one respective candidate value for inclusion in a respective unlocking script of a respective reveal blockchain transaction.

Statement 15. The method of statement 13 or statement 14, comprising:
obtaining an encrypted message; and
using the shared cryptographic key to decrypt the encrypted message.

Statement 16. The method of any of statements 13 to 15, comprising:
encrypting a message using the shared cryptographic key to generate an encrypted message; and
making the encrypted message available to the first party.

Statement 17. A computer-implemented method for enabling a second party to determine a shared cryptographic key, wherein a first party has a first private key and corresponding first public key, and the second party has a second private key and corresponding second public key, wherein a blockchain comprises a puzzle blockchain transaction, wherein the puzzle blockchain transaction comprises one or more respective outputs, each respective output comprising a respective puzzle locking script, wherein each respective puzzle locking script comprises a respective target public key and is configured to, when executed together with a respective unlocking script comprising a respective candidate value, convert the respective candidate value into a respective candidate public key and require the respective candidate public key to match the respective target public key, and wherein the method is performed by a third party and comprises:
generating one or more respective candidate values;
generating one or more respective reveal blockchain transactions, wherein each respective reveal blockchain transaction comprises one or more respective inputs, each respective input referencing a respective one of the one or more respective outputs of the puzzle blockchain transaction and comprising a respective unlocking script, each respective unlocking script comprising a respective candidate value; and
sending the one or more respective reveal blockchain transactions to one or more blockchain nodes of a blockchain network, the first party, and/or the second party.

Statement 18. The method of statement 17, wherein each respective puzzle locking script is configured to require a respective signature corresponding to a respective public key, and wherein at least one of the respective unlocking scripts comprises a respective signature corresponding to a third public key associated with the third party.

Statement 19. The method of statement 16 or statement 17, wherein the third party comprises the first party or the second party.

Statement 20. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 19.

Statement 21. A computer program embodied on computer-readable storage and configured so as, when run on one or more processors, to perform the method of any of statements 1 to 19.

According to another aspect disclosed herein, there may be provided a method comprising the actions of the first party and the second party. According to another aspect disclosed herein, there may be provided a system comprising the computer equipment of the first party and the second party.

According to another aspect disclosed herein, there may be provided a method comprising the actions of the first party and the third party. According to another aspect disclosed herein, there may be provided a system comprising the computer equipment of the first party and the third party.

According to another aspect disclosed herein, there may be provided a method comprising the actions of the second party and the third party. According to another aspect disclosed herein, there may be provided a system comprising the computer equipment of the second party and the third party.

1. A computer-implemented method for generating a shared cryptographic key and enabling a second party to determine the shared cryptographic key, wherein a first party has a first private key and corresponding first public key, and the second party has a second private key and corresponding second public key, and wherein the method is performed by the first party and comprises:
generating a puzzle blockchain transaction, wherein generating the puzzle blockchain transaction comprises:
generating, for each of one or more respective outputs of the puzzle blockchain transaction, a respective puzzle locking script, wherein each respective puzzle locking script comprises a respective target public key and is configured to, when executed together with a respective unlocking script comprising a respective candidate value, convert the respective candidate value into a respective candidate public key and require the respective candidate public key to match the respective target public key;
generating the one or more respective outputs of the puzzle blockchain transaction by encoding a respective puzzle locking script into the one or more respective outputs;
sending the puzzle blockchain transaction to one or more blockchain nodes of a blockchain network and/or the second party, and
generating the shared cryptographic key by performing elliptic curve operations using the first private key, the second public key, and each respective target public key, and wherein the second party is configured to generate the shared cryptographic key by performing elliptic curve operation using the second private key, the first public key, and each respective candidate value.

2. (canceled)

3. The method of claim 1, wherein each respective puzzle locking script comprises an elliptic curve generator point and a function configured to perform elliptic curve multiplication of the respective candidate value and the elliptic curve generator point.

4. The method of claim 1, wherein each respective puzzle locking script is configured to require a respective signature corresponding to a respective public key.

5. The method of claim 4, wherein at least one of the respective puzzle locking scripts is configured to require the respective unlocking script to comprise a respective signature corresponding to a respective public key associated with the first party.

6. The method of claim 4, wherein at least one of the respective puzzle locking scripts is configured to require the respective unlocking script to comprise a respective signature corresponding to a respective public key associated with the second party.

7. The method of claim 1, wherein each respective puzzle locking script is configured to require the respective unlocking script to comprise multiple respective signatures, each corresponding to a respective public key, and wherein at least one respective public is associated with the first party.

8. The method of claim 5, wherein the respective public key associated with the first party is the first public key.

9. The method of claim 1, comprising:
encrypting a message using the shared cryptographic key to generate an encrypted message; and
making the encrypted message available to the second party.

10. The method of claim 1, comprising:
providing one or more of the respective candidate values to at least one party for inclusion in one or more respective unlocking scripts, each respective unlocking script configured to unlock a respective puzzle locking script of the puzzle blockchain transaction.

11. The method of claim 7, wherein a reveal blockchain transaction comprises one or more respective unlocking scripts configured to unlock one or more respective puzzle locking scripts of the puzzle blockchain transaction, and wherein the method comprises providing, for inclusion in the respective unlocking script, a respective signature corresponding to the respective public key associated with the first party.

12. The method of claim 11, wherein the reveal blockchain transaction comprises a time lock value, wherein the time lock value prevents the reveal blockchain transaction from being recorded on the blockchain until a time corresponding to the time lock value has passed.

13. A computer-implemented method of generating a shared cryptographic key, wherein a first party has a first private key and a corresponding first public key, and a second party has a second private key and corresponding second public key, wherein a blockchain comprises a puzzle blockchain transaction, wherein the puzzle blockchain transaction comprises one or more respective outputs, each respective output comprising a respective puzzle locking script, wherein each respective puzzle locking script comprises a respective target public key and is configured to, when executed together with a respective unlocking script comprising a respective candidate value, convert the respective candidate value into a respective candidate public key and require the respective candidate public key to match the respective target public key, and wherein the method is performed by the second party and comprises:
obtaining one or more respective reveal blockchain transactions, wherein each respective reveal blockchain transaction comprises one or more respective inputs, each respective input referencing a respective one of the one or more respective outputs of the puzzle blockchain transaction and comprising a respective unlocking script, each respective unlocking script comprising a respective candidate value;
extracting, from the one or more reveal blockchain transactions, one or more respective candidate values; and
generating the shared cryptographic key by performing elliptic curve operations using the second private key, the first public key, and each respective candidate value, wherein the first party is configured to generate the shared cryptographic key by performing elliptic curve operations using the first private key, the second public key, and each respective target public key.

14. The method of claim 13, comprising:
generating at least one respective candidate value; and
providing the at least one respective candidate value for inclusion in a respective unlocking script of a respective reveal blockchain transaction.

15. The method of claim 13, comprising:
obtaining an encrypted message; and
using the shared cryptographic key to decrypt the encrypted message.

16. The method of claim 13, comprising:
encrypting a message using the shared cryptographic key to generate an encrypted message; and
making the encrypted message available to the first party.

17. A computer-implemented method for enabling a second party to determine a shared cryptographic key, wherein a first party has a first private key and corresponding first public key, and the second party has a second private key and corresponding second public key, wherein a blockchain comprises a puzzle blockchain transaction, wherein the puzzle blockchain transaction comprises one or more respective outputs, each respective output comprising a respective puzzle locking script, wherein each respective puzzle locking script comprises a respective target public key and is configured to, when executed together with a respective unlocking script comprising a respective candidate value, convert the respective candidate value into a respective candidate public key and require the respective candidate public key to match the respective target public key, and wherein the method is performed by a third party and comprises:
generating one or more respective candidate values;
generating one or more respective reveal blockchain transactions, wherein generating each respective reveal blockchain transaction comprises:
generating, for one or more respective inputs of the respective reveal blockchain transaction, a respective unlocking script, each respective unlocking script comprising a respective candidate value; and
generating the one or more respective inputs by encoding a respective unlocking script into the respective input and including a respective reference that references a respective one of the one or more respective outputs of the puzzle blockchain transaction; and
sending the one or more respective reveal blockchain transactions to one or more blockchain nodes of a blockchain network, the first party, and/or the second party.

18. The method of claim 17, wherein each respective puzzle locking script is configured to require a respective signature corresponding to a respective public key, and wherein at least one of the respective unlocking scripts comprises a respective signature corresponding to a third public key associated with the third party.

19. The method of claim 17, wherein the third party comprises the first party or the second party.

20-21. (canceled)
